(19) United States
(12) Patent Application Publication
(10) Pub. No.: US 2011/0157007 A1
(43) Pub. Date: Jun. 30, 2011

(54) OPTICAL PEN AND OPERATING METHOD OF THE SAME

(75) Inventor: Wei-Chieh Chen, Taoyuan County (TW)

(73) Assignee: BENQ CORPORATION, Taipei (TW)

(21) Appl. No.: 12/972,561

(22) Filed: Dec. 20, 2010

(30) Foreign Application Priority Data
Dec. 24, 2009 (TW) 98144863

(51) Int. Cl. G09G 5/00

(52) U.S. Cl. 345/156

(57) ABSTRACT

An optical pen comprises a housing, a pen body, a pen tip, a switch and a control unit. The pen body, disposed inside the housing, has a hinge mechanism allowing the pivoting of the pen body. The pen tip is disposed at a front end of the pen body and protruded from the housing. When the pen tip touches a projection surface, the pen body is rotated through the hinge mechanism to trigger the switch. The switch disposed inside the housing is electrically connected to the control unit. When the switch is triggered, the control unit outputs an electrical signal.

This application claims the benefit of Taiwan application Serial No. 098144863, filed Dec. 24, 2009, the subject matter of which is incorporated herein by reference.

### BACKGROUND OF THE DISCLOSURE

1. Field of the Disclosure

The disclosure relates in general to an optical pen and an operating method of the same, and more particularly to an optical pen enabling the users to easily trigger the switch (to perform a function similar to the conventional mouse) during the hand-writing process without pressing any key or button.

2. Description of the Related Art

Of the interactive electronic assemblies which provide an interesting and versatile interactive presentation environment, the interactive electronic white board is most popular. The interactive electronic white board can communicate with the computer. For example, the interactive electronic white board can be connected to a computer via a USB cable, and the contents of the computer can be projected onto the screen of an electronic white board by a projector. With the support of necessary application software, the written contents can be synchronically displayed on the computer, so that the users can directly operate the screen of the computer so as to create an interactive environment for presentation or teaching. During a conference, the users may choose to touch the white board with a finger or a stylus or operate the white board with an optical pen. The friendly interface design enables the users to operate various application programs and perform all of the hand-writing or drawing functions without having to change their habits. Furthermore, the users can store the annotated contents and produce e-learning materials or minutes of meeting, so that the ideas presented during presentation, teaching or brain storming can be more completely retained.

Moreover, the interactive electronic white board not only provides an environment easier for the presenter or teacher to explain the contents but also makes complicated data or contents easier to be presented or explained. With the support of existing software, a large volume of information can be flexibly used and displayed on the electronic white board, so that the audience can be more focused on the presentation or discussion, and the interaction between the speaker and the audience is further improved. Unlike the conventional black board or white board which needs to be wiped off, the data can be quickly and conveniently displayed on the interactive electronic white board without having to be wiped off, and the interactive electronic white board can be operated with finger, stylus or optical pen without arousing a cloud of chalk dust or an unpleasant odor of white board markers. Therefore, the interactive electronic white board has great potential to become an indispensible, important electronic device.

The most commonly seen interactive electronic white boards are mainly divided into four types, including a two-way infrared sensing type, an electromagnetic inducting type, a pressure touch sensing type, and a ultrasonic sensing type. Despite the principles of operation may differ from one another, the inputting, operation and interactive function of various interactive electronic white boards are basically the same, and the inputting tool such as finger or particular optical pen is dependent on the design. The infrared sensing type electronic white board achieves positioning with an infrared sensor, and the users can “write” with finger or stylus as the inputting tool. The pressure touch sensitive electronic white board formed by multi-layers mainly comprises a resistive film and a conductive film for detecting horizontal and vertical signals. During the inputting of hand-writing, the users may press the white board with their finger or the pen tip of a stylus, and the conductive film will contact the resistive film to generate an electronic signal containing the horizontal (X-axis) and the vertical (Y-axis) coordinates, then the relative position of the signal is further transmitted back to the computer. The electromagnetic inductive type electronic white board has induction coils embedded therein for detecting the signal of the horizontal and the vertical positions. A signal emission device is disposed in the sensing pen which emits a signal during moving or handwriting. When receiving the signal, the induction coil of the white board will perform positioning and transmit the relative position back to the computer. Thus, the electromagnetic inductive type electronic white board needs a particular sensing pen which exchanges signal with the induction coil of the white board to perform positioning. The ultrasonic sensing type electronic white board has an ultrasonic receiver on each of the two sides of the upper edge of the white board (or other hand-writing medium), and the signal is emitted by an exclusive emitter, which is normally realized as a pen. When the emitter (ex: a pen) moves on the surface of the white board, the receiver will receive a signal from the emitter, and further position the location of the emitter on the white board according to the receiving time, distance and angle of the received signal.

However, when the users would like to use one of the above interactive electronic products for information presentation or exchange, an electronic white board with particular design must be available in addition to a computer and a projector, and these facilities are restrictive and inconvenient to the user. Therefore, it has always been a prominent for the industries to provide an interactive electronic product which uses existing facilities such as computer and projector and further uses a smooth surface as a projection screen so that interactive information exchange can be held anytime, anywhere. The optical pen, which exchanges signals with the projector by way of photo-optical sensing so as to achieve positioning, decrease the cost and is operable on any surface. Therefore, the optical pen has gradually become a prospective hand-writing input product.

Most of the optical pens currently available in the market perform the functions similar to the conventional mouse by way of press key. The users have to keep pressing the key of the optical pen during hand-writing or drawing process. By pressing the key, the control unit connected to the key will generate and transmit an electrical signal to an external electronic device, which then processes the electrical signal and performs a predetermined function, such as the execution function corresponding to the current position of the cursor (such as the function of displaying the corresponding stroke or shape). However, to write or draw and at the same time keep pressing the key is not an easy job, and the users may even let go of the key due to sore fingers particularly when the amount and the duration of hand writing is large and long, not only affecting the sensitivity of the optical pen but also causing burden to the user's health.

### SUMMARY OF THE DISCLOSURE

The disclosure is directed to an optical pen with particular structural design which enables the users to trigger the switch (to perform a function similar to a conventional mouse) without pressing the key during the hand-writing process, and makes the operation of the optical pen even more convenient.

According to the first aspect of the present disclosure, an optical pen is provided. The optical pen comprises a housing, a pen body, a pen tip, a switch and a control unit. The pen body, disposed inside the housing, has a hinge mechanism allowing the pivoting of the pen body. The pen tip is disposed at a front end of the pen body and protruded from the housing. When the pen tip touches a projection surface, the pen body is rotated through the hinge mechanism to trigger the switch. The switch disposed inside the housing is electrically connected to the control unit. When the switch is triggered, the control unit outputs an electrical signal.

According to the second aspect of the present disclosure, an operating method is provided. First, an optical pen, which cooperates with a projection device and a projection surface, is provided. The optical pen comprises a housing, a pen tip, a pen body, a switch, a hinge mechanism and a control unit, the pen body, the switch, the hinge mechanism and the control unit disposed inside the housing. The pen tip is disposed at a front end of the pen body and protruded from the housing, the pen body allows pivoting on the hinge mechanism, and the switch is electrically connected to the control unit.

Then, the pen tip touches a projection surface, so that the pen body is rotated through the hinge mechanism to trigger the switch, and the control unit outputs an electrical signal.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1A shows an optical pen structure according to a first embodiment of the disclosure being in a non-writing state;

FIG. 1B shows the optical pen structure of FIG. 1A being in a writing state;

FIG. 1C shows the relative position among a pen body, a pen tip and a switch of the optical pen of the first embodiment of the disclosure;

FIG. 2A shows an optical pen structure according to a second embodiment of the disclosure being in a non-writing state;

FIG. 2B shows the optical pen structure of FIG. 1A being in a writing state;

FIG. 2C shows the relative position among a pen body, a pen tip and a switch of the optical pen of the second embodiment of the disclosure;

FIG. 3A shows an optical pen structure according to a third embodiment of the disclosure being in a non-writing state;

FIG. 3B shows the optical pen structure of FIG. 3A being in a writing state;

FIG. 3C shows the relative position among a pen body, a pen tip and a switch of the optical pen of the third embodiment of the disclosure;

FIG. 4 shows a pen body, a pen tip, a hinge mechanism and a switch of an optical pen according to a fourth embodiment of the disclosure;

FIG. 5A shows a pen body, a pen tip and a switch according to a fifth embodiment of the disclosure; and

FIG. 5B is a cross-sectional view showing the switch of FIG. 5A being triggered.

### DETAILED DESCRIPTION OF THE DISCLOSURE

The embodiment provides an optical pen. The particular structural design of the optical pen replaces the conventional key design and enables the users to trigger the switch (to perform a predetermined function similar to the conventional mouse) without pressing any key during the hand-writing process. Moreover, the optical pen of the embodiments of the disclosure can be gripped in many different ways, so that the users with different pen gripping habits will find it easy and convenient to write with the optical pen of the embodiments of the disclosure. The optical pen maintains the same sensitivity for a large amount of hand-writing over a long duration, and makes hand writing easy and convenient without causing any harm to the user's health.

A number of embodiments of the disclosure are disclosed below. However, the structure of the optical pen disclosed in the following embodiments is for exemplification only, not for limiting the scope of protection of the disclosure. Furthermore, in the following embodiments, secondary elements are omitted to highlight the technical features of the disclosure. Examples of the secondary elements include optical components such as light source, light sensor and lens that are used for receiving optical signals and are generally known to those who are skilled in the technology of the disclosure.

### First Embodiment

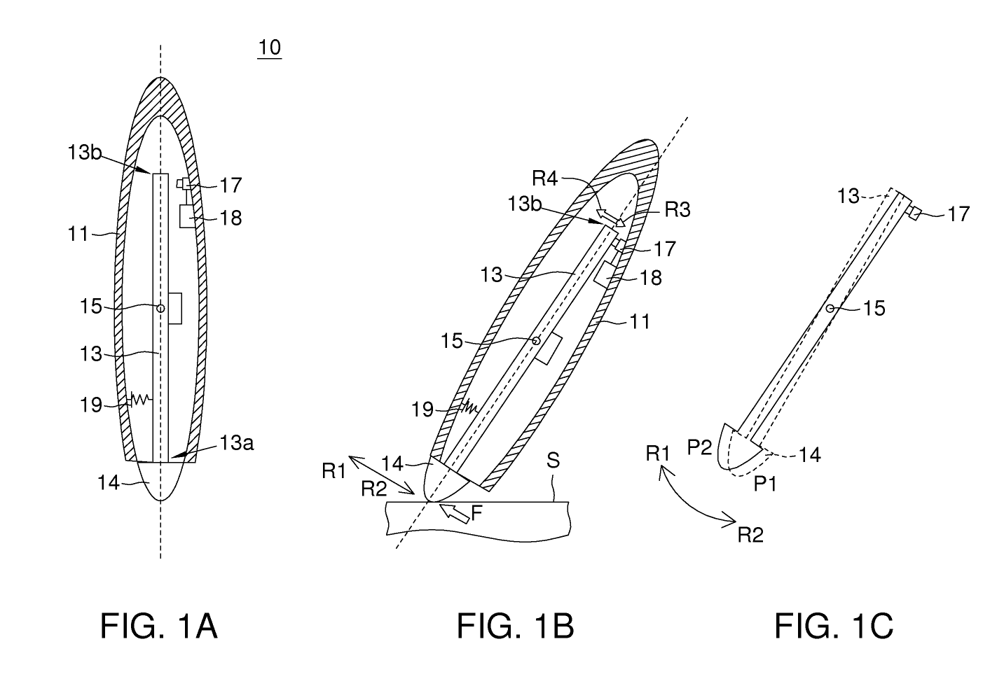

Referring to FIG. 1A, FIG. 1B and FIG. 10. FIG. 1A shows an optical pen structure according to a first embodiment of the disclosure being in a non-writing state. The optical pen 10 of the first embodiment at least includes a housing 11, a pen body 13, a pen tip 14, a switch 17 and a control unit 18. The pen body 13 disposed inside the housing 11 allows the pen body 13 to pivot on a hinge mechanism 15. The pen tip 14 is disposed at a front end 13a of the pen body 13 and protruded from the housing 11. The pen tip 14, when pushed by an external force, drives the pen body 13 to rotate around the hinge mechanism 15. The switch 17 disposed inside the housing 11 is electrically connected to a control unit 18. When the switch 17 is triggered, the wireless emitter disposed inside the control unit 18 outputs a corresponding electrical signal.

FIG. 1B shows the optical pen structure of FIG. 1 A being in a writing state. When the users writes with the optical pen 10 gripped at hand, the pen tip 14 touches a projection surface S, and the projection surface S applies a reacting external force F to the pen tip 14 at the same time. When receiving the external force F, the pen tip 14 is moved towards the direction R1 and at the same time drives the pen body 13 to move towards the direction R1 through the hinge mechanism 15, and the terminal end 13b of the pen body 13 is moved towards the direction R3 to trigger the switch 17. The control unit 18 electrically connected to the switch 17 generates an electrical signal, and further transmits the electrical signal to an external electronic device (not shown) such as a projection device with wireless receiver or a microprocessor (not shown) disposed inside the optical pen 10. The microprocessor inside the projection device or the optical pen 10 will then decode the electrical signal transmitted from the control unit 18. Based on the predetermined conditions, the microprocessor inside the projection device directly displays the contents performed by the optical pen on the projection surface S but the computer frame is not edited. Alternatively, the contents are displayed on the projection surface S and the computer frame is edited as well. In addition, the projection surface S can be any object with a planar or a curved surface, such as a white board, a wall, and the cloth, and no further restriction is imposed in the disclosure.

In an embodiment, when the users continually drives the pen tip 14 to move on the projection surface S laterally, as long as the projection surface S keeps applying a reacting force to the pen tip 14, the pen tip 14 will drive the pen body 13 to keep pressing the switch 17 through the hinge mechanism 15, so that the control unit 18 keeps transmitting a corresponding electrical signal to an external electronic device (such as a projection device or a computer) to perform a predetermined function, such as the execution function corresponding to the current position of the cursor (such as the function of displaying the corresponding stroke or shape).

Referring to FIG. 10, showing the relative position among a pen body, a pen tip and a switch of the optical pen of the first embodiment. As indicated in FIG. 10, the pen tip 14, when receiving an external force, moves towards the direction R1 and at the same time drives the pen body 13 to move through the hinge mechanism 15 so as to trigger the switch 17. Meanwhile, the pen tip 14 is located at a writing position P2. When the external force is no more applied on the pen tip 14 (such as being removed from the projection surface S), the pen tip 14 is moved towards the direction R2 to return to an initial position P1, and at the same time the pen body 13 is driven off the switch 17 (that is, the terminal end 13b of the pen body 13 is moved towards the direction R4 from the direction R3; please refer to FIG. 1B for the directions R3 and R4) through the hinge mechanism 15 and makes the switch 17 short-circuited.

The optical pen of the present embodiment further comprises an elastic member connected to the pen tip 14 or the pen body 13 to provide a restoring force which enables the pen tip 14 to return to the original position after the pen tip is off the projection surface S. Referring to FIG. 1A, FIG. 1B and FIG. 10. In the first embodiment, the elastic member is a spring 19. Before the optical pen 10 is used for hand-writing and the external force F is not yet applied to the pen tip 14, the spring 19 is at a normal length (without extension or compression), and the switch 17 is not triggered yet. When the pen tip 14 touches the projection surface S and starts to write, the pen tip 14 receives an external force to move towards the direction R1 and compress the spring 19, and the switch 17 is also triggered by the terminal end 13b of the pen body 13 and becomes the ON state. Meanwhile, the spring 19, being deformed, generates an elasticity restoring force, and the pen tip 14 is also located at a writing position P2. When the pen tip 14 is removed from the projection surface S, the projection surface S no more applies the external force F to the pen tip 14, the pen tip 14 is moved towards the direction R2 and returns to the initial position P1 due to the elasticity restoring force of the spring 19, and the switch 17 also resumes the OFF state.

In the first embodiment, the switch 17 is positioned corresponding to the terminal end 13b of the pen body 13, so that when the pen tip 14 is moved towards the direction R1, the terminal end 13b of the pen body 13 is moved towards the direction R3 so as to trigger the switch 17. However, such design is merely one of the many possible implementations, and the disclosure is not limited thereto. The relative position between the switch 17 and the hinge mechanism can be adjusted to fit actual needs.

For the elements used in the following embodiments of the disclosure that are similar to that used in the first embodiment, the same designations are used and the similarities are not repeated.

### Second Embodiment

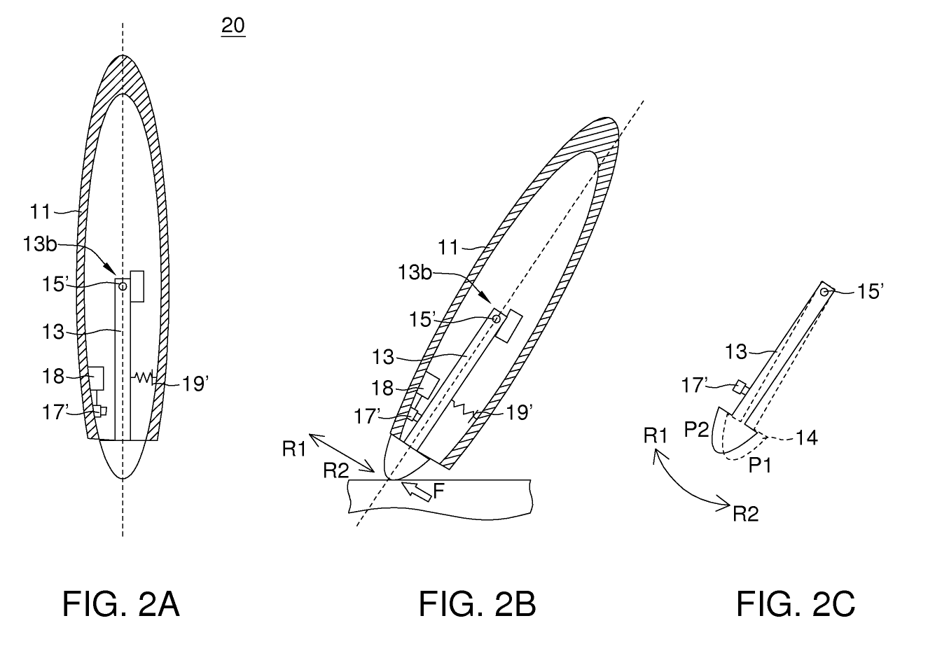

Referring to FIG. 2A, FIG. 2B and FIG. 2C. FIG. 2A shows an optical pen structure according to a second embodiment of the disclosure being in a non-writing state. FIG. 2B shows the optical pen structure of FIG. 1A being in a writing state. FIG. 2C shows the relative position among a pen body, a pen tip and a switch of the optical pen of the second embodiment. The elements and principles of operation used in the optical pen 20 of the second embodiment and the optical pen 10 of the first embodiment are basically the same except that the relative position between the switch and the hinge mechanism is changed.

In the optical pen 10 of the first embodiment, the hinge mechanism 15 is disposed between the terminal end 13b of the pen body 13 and the pen tip 14, and the switch 17 is disposed on one side of the optical pen corresponding to the terminal end 13b of the pen body 13, so that when the pen tip 14 touches the projection surface and drives the pen body 13 towards the direction R1, the terminal end 13b of the pen body 13 is moved towards the direction R2 (opposite to the direction R1) so as to trigger the switch 17. In the optical pen 20 of the second embodiment, the hinge mechanism 15′ is disposed close to the terminal end 13b of the pen body 13, and the switch 17′ is positioned corresponding to the space between the hinge mechanism 15′and the pen tip 14, so that when the pen tip 14 touches the projection surface S and drives the pen body towards the direction R1, the first half of the pen body 13 also moves towards the direction R1 so as to trigger the switch 17′.

Moreover, the optical pen 20 of the second embodiment, through the connection between a spring 19′ and the pen body 13, can also provide an elasticity restoring force, which returns the pen tip 14 to the original position after the external force disappears. Referring to FIG. 2A˜FIG. 2C. Before the optical pen 20 is used for hand-writing and the external force F is not yet applied to the pen tip 14, the spring 19′ is at a normal length (without extension or compression as indicated in FIG. 2A), the switch 17′ is not triggered either. When the pen tip 14 touches the projection surface S and starts to write, the pen tip 14 receives an external force to move towards the direction R1 and extends the spring 19′ (as indicated in FIG. 2B), so that the switch 17′ is triggered by the first half of the pen body 13 and becomes the ON state. Meanwhile, the deformed spring 19′ generates an elasticity restoring force, and the pen tip 14 is also located at a writing position P2. When the pen tip 14 is removed from the projection surface S, the projection surface S no more applies an external force F to the pen tip 14, and through the elasticity restoring force of the spring 19′, the pen tip 14 is moved towards the direction R2 and returns to the initial position P1, and the switch 17′ also resumes the OFF state.

However, in practical application, the pen body 13 and the pen tip 14 do not have to return to their original positions by the restoring force provided by the spring 19/19′ of the first and the second embodiment, and other elastic members can also do so. Or, the restoring force can be provided through the structural design of the switch or a hinge mechanism with restoring function.

### Third Embodiment

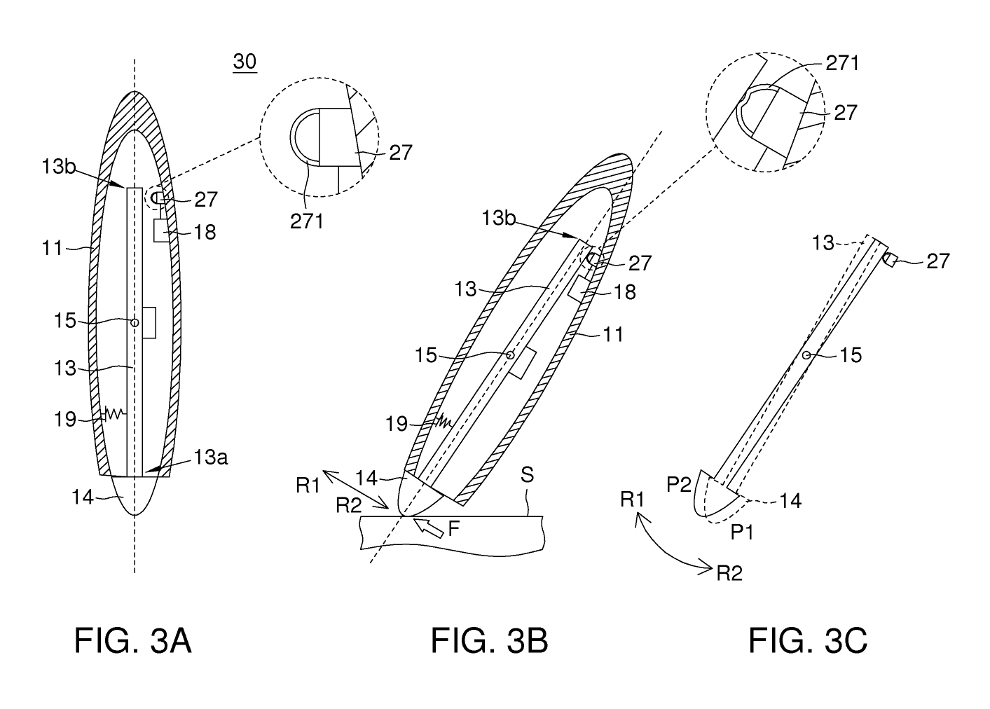

Referring to FIG. 3A, FIG. 3B and FIG. 3C. FIG. 3A shows an optical pen structure according to a third embodiment of the disclosure being in a non-writing state. FIG. 3B shows the optical pen structure of FIG. 3A being in a writing state. FIG. 3C shows the relative position among a pen body, a pen tip and a switch of the optical pen of the third embodiment. The elements and principles of operation used in the optical pen 30 of the third embodiment and that used in the optical pen 10 of the first embodiment are basically the same except that the switch 27 of the third embodiment has particular structural design for enabling the pen body 13 and the pen tip 14 to return to their original positions without using the spring 19 of the first embodiment.

The optical pen 30 of the third embodiment comprises a housing 11, a pen body 13, a pen tip 14, a switch 27 and a control unit 18. The switch 27 is a metal dome switch, which is a curved metal piece and has elasticity. Before the optical pen 10 is used for hand-writing and the external force F is not yet applied to the pen tip 14, the spring 19′ is at a normal length (without extension or compression as indicated in FIG. 2A), the metal dome 271 is normally curved, and the switch 27 is not triggered. When the pen tip 14 touches the projection surface S and starts to write, the projection surface S applies a reacting force F to the pen tip 14. The pen tip 14, when receiving the external force F, moves towards the direction R1 and at the same time drives the pen body 13 through the hinge mechanism 15 to move towards the direction R1, and the terminal end 13b of the pen body 13 presses the metal dome 271 so that the switch 27 is triggered and the switch 27 becomes the ON state. The control unit 18 electrically connected to the switch 27 generates an electrical signal and further transmits the electrical signal to an external electronic device (not illustrated) such as a projection device with wireless receiver and microprocessor, or a microprocessor (not shown) disposed inside the optical pen 30. Meanwhile, the deformed metal dome 271 generates an elasticity restoring force, and the pen tip 14 is also located at a writing position P2. When the pen tip 14 is removed from the projection surface S, the projection surface S no more applies an external force F to the pen tip 14, and the elasticity restoring force of the metal dome 271 enables the pen tip 14 to moves towards the direction R2 and returns to the initial position P1, and the switch 27 also resumes the OFF state.

In the first to the third embodiments, the hinge mechanism and the switch are respectively disposed at different positions, but the disclosure is not limited thereto. Through other mechanisms, the pen body can also move between different positions so as to turn the switch on or off. For example, the hinge mechanism is disposed in the switch, when the pen body/hinge mechanism is at a first position, the switch is in an OFF state; and when the pen tip drives the pen body to move and the pen body/hinge mechanism is rotated to a second position, the switch is in an ON state.

### Fourth Embodiment

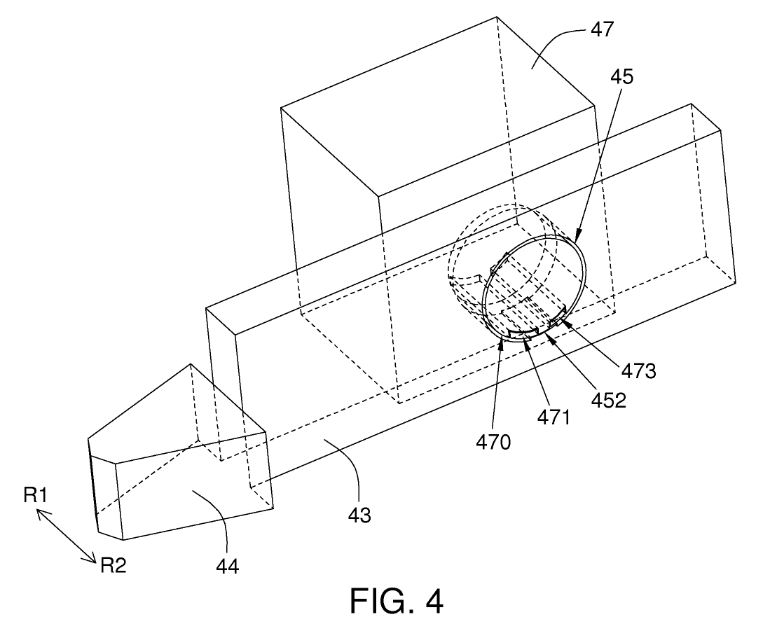

FIG. 4 shows a pen body, a pen tip, a hinge mechanism and a switch of an optical pen according to a fourth embodiment of the disclosure. In the fourth embodiment, the switch 47 and the hinge mechanism 45 are co-axial. As indicated in FIG. 4, the hinge mechanism 45 is disposed inside the pen body 43 and mounted on the bearing 470 of the switch 47. The switch 47 has a positive contact 471 and a negative contact 473, and the hinge mechanism 45 has a conductive piece 452 (such as a metal elastic piece).

The principles of the operation of the optical pen of the fourth embodiment are similar to that disclosed in the above embodiments. Before the optical pen is used for hand-writing and the external force F is not yet applied to the pen tip 44, the hinge mechanism 45 is located at a first position, and the positive contact 471 and the negative contact 473 of the switch 47 are not yet connected by the conductive piece 452, so the switch 47 is not triggered and presents a short-circuited condition. When the optical pen is used for hand-writing, the pen tip 44 receives an external force to move towards the direction R1 and at the same time drives the pen body 43 to move through the hinge mechanism 45. Meanwhile, the hinge mechanism 45 is synchronically rotated to a second position (as indicated in FIG. 4) at which the conductive piece 452 connects the positive contact 471 and negative contact 473 of the switch 47, wherein the positive contact 471 and the negative contact 473 can be electrically connected through the conductive piece 452, and the switch 47 is in an ON state. In addition, through appropriate design, the hinge mechanism 45 can generate a torque during rotation. When the external force applied to the pen tip 44 disappears, the shaft torque enables the hinge mechanism 45 to return to the first position and pulls back the pen tip 44 simultaneously. Meanwhile, the conductive piece 452 is off the position connecting the positive contact 471 and the negative contact 473 (for example, the conductive piece 452 returns to the position corresponding to the negative contact 473), so that the switch 47 is now short-circuited again.

### Fifth Embodiment

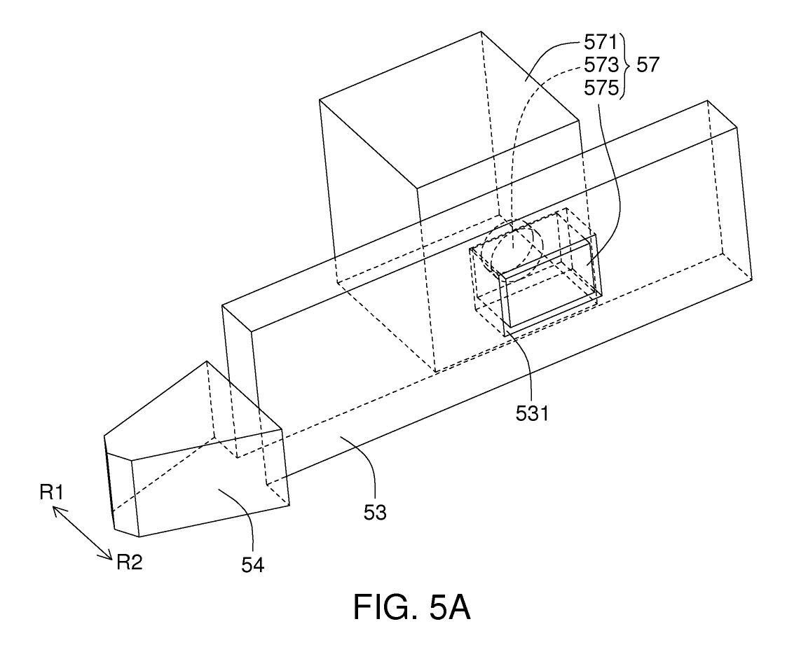

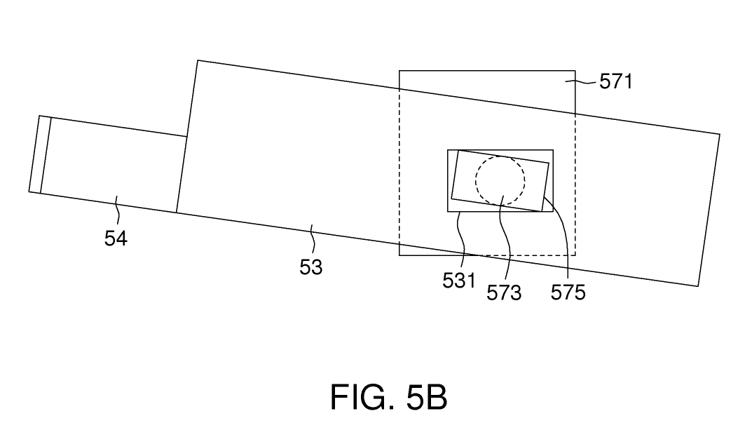

FIG. 5A shows a pen body, a pen tip and a switch according to a fifth embodiment of the disclosure. FIG. 5B is a cross-sectional view showing the switch of FIG. 5A being triggered. In the optical pen of the fifth embodiment, the switch 57 comprises a switch body 571 and a squared shaft 573, wherein a dome shaft 575 is disposed on the switch body 571 for connecting the body 571 and the squared shaft 573. The pen body 53 has a squared hole 531 for receiving the squared shaft 573, wherein the size of the squared hole 531 is slightly larger than that of the squared shaft 573. The outer surface of the squared shaft 573 and the inner wall of the squared hole 531 have opposite polarities. Before an external force is applied to the pen tip 54, the squared hole 531 of the pen body 53 does not contact the squared shaft 551 of the switch 57, so that the switch 57 is not triggered. The pen tip 54, when receiving the external force, moves towards the direction R1 and at the same time drives the pen body 53 towards the direction R1 as indicated in FIG. 5B, the squared hole 531 rotated along with the pen body 53 will contact the squared shaft 575 and form a conducting path for the switch 57 to be triggered. In an embodiment, the external force applied to the pen tip 54 may even drive the squared shaft 573 to rotate with respect to the dome shaft 575. Through appropriate design, a shaft torque can be generated between the dome shaft 575 and the squared shaft 573. When the external force applied to the pen tip 54 disappears, the shaft torque rotates the squared shaft 573 and pulls back the pen tip 54, so that the squared hole 531 and the squared shaft 575 of the optical pen return to the state as indicated in FIG. 5A and makes the switch 57 short-circuited.

According to the optical pen disclosed in the above embodiments of the disclosure, the users can easily trigger the switch by dragging the optical pen laterally (perform a function similar to the conventional mouse) without pressing the key during the hand-writing process. The users can write with the optical pen of the disclosure as if writing with an ordinary pen, and will not suffer from sore fingers even after a long duration of hand-writing. Different users may grip the pen in different gestures. The pen tip normally forms an inclined angle with the inputting surface of hand-writing. Through the design of triggering the switch by dragging the pen tip laterally, the optical pen of the embodiments of the disclosure is convenient and handy for the users whose pen-gripping gestures are different. In comparison to the conventional optical pen with press-key, the optical pen of the embodiments of the disclosure makes the users feel more convenient during the hand-writing process, and the sensitivity of the optical pen will not be affected by the user's pen-gripping habits.

While the disclosure has been described by way of example and in terms of the embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical pen, comprising:
a housing;
a pen body, disposed inside the housing, and the pen body having a hinge mechanism allowing the pivoting of the pen body;
a pen tip, disposed at a front end of the pen body and protruded from the housing, wherein when the pen tip touches a projection surface, the pen body is rotated by the hinge mechanism;
a switch, disposed inside the housing, wherein the pen body is rotated through the hinge mechanism so as to trigger the switch; and
a control unit, electrically connected to the switch, wherein the control unit outputs an electrical signal when the switch is triggered.

2. The optical pen according to claim 1, further comprising an elastic member capable of driving the pen tip, the pen tip compresses the elastic member when the pen tip touches the projection surface, and the pen tip is driven to an initial position by an elasticity restoring force of the elastic member when the pen tip is off the projection surface.

3. The optical pen according to claim 2, wherein the elastic member is connected to the pen body.

4. The optical pen according to claim 1, wherein the triggering mechanism of the switch is an elastic member, the pen body touches the elastic member so as to trigger the switch when the pen body is rotated, and the pen body is driven to an initial position by an elasticity restoring force of the elastic member when the pen body is off the elastic member.

5. The optical pen according to claim 4, wherein the elastic member is a metal dome.

6. The optical pen according to claim 1, wherein the hinge mechanism is disposed between a terminal end and the pen tip of the pen body.

7. The optical pen according to claim 6, wherein the switch is disposed on one side of the optical pen corresponding to the terminal end of the pen body, and when the pen tip touches the projection surface and drives the pen body towards a first direction, the terminal end of the pen body is driven to move towards an opposite direction of the first direction so as to trigger the switch.

8. The optical pen according to claim 6, wherein the switch is positioned corresponding to a space between the hinge mechanism and the pen tip, and when the pen tip touches the projection surface and drives the pen body towards a first direction, the pen body is also driven to move towards the first direction so as to trigger the switch.

9. The optical pen according to claim 1, wherein the hinge mechanism is disposed at a terminal end of the pen body.

10. The optical pen according to claim 9, wherein the switch is positioned corresponding to a space between the hinge mechanism and the pen tip, and when the pen tip touches the projection surface and drives the pen body towards a first direction, the pen body is also driven to move towards the first direction so as to trigger the switch.

11. The optical pen according to claim 1, wherein the hinge mechanism is disposed at the switch, the switch is in an OFF state when the hinge mechanism is at a first position, and the switch is in an ON state when the pen tip drives the pen body so that the hinge mechanism is rotated to a second position.

12. The optical pen according to claim 11, wherein the switch and the hinge mechanism are co-axial.

13. The optical pen according to claim 11, wherein the hinge mechanism is located inside the pen body and mounted on a bearing of the switch.

14. The optical pen according to claim 13, wherein the switch has a positive contact and a negative contact, the hinge mechanism has a conductive piece, the positive contact and the negative contact are short-circuited when the hinge mechanism is at the first position, and the positive contact and the negative contact are electrically connected through the conductive piece when the hinge mechanism is rotated to the second position.

15. The optical pen according to claim 14, wherein the conductive piece is a metal elastic piece.

16. The optical pen according to claim 1, wherein when the switch is triggered, the control unit outputs the electrical signal to an external electronic device to perform a predetermined function comprising a hand-writing input function.

17. An operating method of an optical pen, comprising:
providing an optical pen, which cooperates with a projection device and a projection surface, wherein the optical pen comprises a housing, a pen tip, and a pen body, a switch, a hinge mechanism and a control unit, the pen body, the switch, the hinge mechanism and the control unit are disposed inside the housing, the pen tip is disposed at a front end of the pen body and protruded from the housing, the pen body allows pivoting on the hinge mechanism, and the switch is electrically connected to the control unit; and
touching a projection surface with the pen tip so that the pen body is rotated through the hinge mechanism to trigger the switch, and the control unit outputs an electrical signal when the switch is triggered.

18. The method according to claim 17, further comprising:
moving the pen tip from the projection surface, and the pen tip is driven to an initial position, wherein the hinge mechanism also drives the pen body and makes the switch short-circuited.

19. The method according to claim 17, wherein the optical pen further comprises an elastic member capable of driving the pen tip, the elastic member is compressed when the pen tip touches the projection surface, and the pen tip is driven to the initial position through an elasticity restoring force of the elastic member when the pen tip is off the projection surface.

20. The method according to claim 17, wherein the triggering mechanism of the switch is an elastic member, which triggers the switch when the pen body is rotated to touch the elastic member, and provides an elasticity restoring force for driving the pen body to the initial position when the pen body is off the elastic member.

21. The method according to claim 17, wherein the hinge mechanism of the optical pen is disposed between a terminal end of the pen body and the pen tip, the switch is disposed on one side of the optical pen corresponding to the terminal end of the pen body, and when the pen tip touches the projection surface and drives the pen body towards a first direction, the terminal end of the pen body is driven to move towards an opposite direction of the first direction to trigger the switch.

22. The method according to claim 17, wherein the hinge mechanism of the optical pen is disposed between a terminal end of the pen body and the pen tip, the switch is positioned corresponding to a space between the hinge mechanism and the pen tip, and when the pen tip touches the projection surface and drives the pen body towards a first direction, the pen body is also driven to move towards the first direction so as to trigger the switch.

23. The method according to claim 17, wherein the hinge mechanism of the optical pen is disposed at a terminal end of the pen body, the switch is disposed between the hinge mechanism and the pen tip, and when the pen tip touches the projection surface and drives the pen body towards a first direction, the pen body is also driven to move towards the first direction so as to trigger the switch.

24. The method according to claim 17, wherein the hinge mechanism of the optical pen is disposed in the switch, and the switch is in an OFF state when the pen tip is off the projection surface and the hinge mechanism is at a first position, and the switch is in an ON state when the pen tip touches the projection surface and drives the pen body so that the hinge mechanism is rotated to a second position.

25. The method according to claim 17, wherein the hinge mechanism is disposed inside the pen body and mounted on a bearing of the switch, the switch has a positive contact and a negative contact, the hinge mechanism has a conductive piece, and when the pen tip is off the projection surface, the hinge mechanism is at the first position, and the positive contact and the negative contact are short-circuited, but when the pen tip touches the projection surface, the hinge mechanism is rotated to the second position, and the positive contact and the negative contact are electrically connected through the conductive piece to turn on the switch.

26. The method according to claim 25, wherein the conductive piece is a metal elastic piece.

27. The method according to claim 17, wherein when the switch is continually triggered, the control unit outputs a group of electrical signals to an external electronic device to perform a predetermined function comprising a hand-writing input function.
